(19) United States
(12) Patent Application Publication
(10) Pub. No.: US 2011/0261292 A1
(43) Pub. Date: Oct. 27, 2011

(54) SYSTEM AND METHOD FOR DECREASING THE POWER REQUIREMENTS OF A BACKLIGHT FOR A LIQUID CRYSTAL DISPLAY

(75) Inventor: Estill Thone Hall, JR., Fishers, IN (US)

(73) Assignee: SHENZHEN TCL NEW TECHNOLOGY LTD., Shekou, Shenzhen, Guangdong (CN)

(21) Appl. No.: 13/127,442

(22) PCT Filed: Jul. 17, 2009
(86) PCT No.: PCT/US2009/051037

§ 371 Date: May 3, 2011

(30) Foreign Application Priority Data
Dec. 12, 2008 (CN) 200810172781.7

(51) Int. Cl. G02F 1/13357; H01J 9/24; G02F 1/1335

(52) U.S. Cl. 349/67; 362/97.2; 349/61; 362/97.3; 445/24

(57) ABSTRACT

Embodiments of the present techniques provide a backlight illumination system. The backlight illumination system comprises a light source, such as fluorescent tubes configured to emit light in all directions for illuminating a display. The backlight illumination system further comprises a mirror disposed behind the fluorescent tubes, wherein the mirror includes beveled reflectors configured to focus the emitted light forming a composite image of adjoining light sources, such as a virtual light source. The virtual light source may reduce the number of fluorescent tubes required for a backlit display, which may lower power requirements for the display. This may help to increase battery life in portable devices using such a backlit display.

### TECHNICAL FIELD

The present techniques relate generally to video display systems. More specifically, the present techniques relate to backlight illumination of video display systems, such as liquid crystal displays (LCDs).

### BACKGROUND

This section is intended to introduce the reader to various aspects of art, which may be related to various aspects of the present embodiments that are described and/or claimed below. This discussion is believed to be helpful in providing the reader with background information to facilitate a better understanding of the various aspects of the present embodiments. Accordingly, it should be understood that these statements are to be read in this light, and not as admissions of prior art.

Backlit displays, such as liquid crystal display (LCD) panels, are employed in a variety of display systems. Such systems may include, for example, flat screen computer monitors, portable computers, digital cameras, cellular telephones, hand-held devices, flat screen television sets (TVs), digital watches, and so forth. The LCD panel incorporated in such systems may include a matrix of transistors or other micro-devices acting as electrical switches that modulate light. In cooperation with other components, such as polarizing filters, the modulation of the light may be used to generate an image.

The light used to generate the image may be reflected light, transmitted through the front surface of the LCD and reflected from a mirror behind the LCD, e.g., in LCD watches. In other LCDs, the light may be provided by a light source from the back side of the panel, e.g., a backlight. Generally, color LCDs require a backlight, since reflected light may not adequately illuminate the display. For example, the light used for illuminating an LCD may be provided by a plurality of fluorescent tubes, which are disposed behind the LCD panel.

However, because light generated by such fluorescent tubes is generally emitted uniformly, the LCD panel may receive only a portion of the emitted light. Furthermore, the components of the display that are used to generate the image may block a substantial portion of the light. For example, a polarizing film that may be used in the generation of an image may block as much as 50%, or more, of the light from a backlight. Other components used to improve image quality, such as a diffuser plate, may decrease the light even more.

Various techniques may be employed to increase the overall amount of the backlight emitted by the LCD and, thus, provide a brighter image. For example, a reflective white surface may be placed behind the fluorescent tubes to direct more light to the front of the device. Further, an increased number of fluorescent tubes may be used in the display. However, an increase in the number of fluorescent tubes increases the power consumption of a device, which may decrease the battery life in a portable device. An increase in the number of fluorescent tubes may also increase the heat generated by the device, which may increase the stress on components and decrease the lifespan of the display.

### BRIEF DESCRIPTION OF THE DRAWINGS

Advantages of embodiments of the present techniques may become apparent upon reading the following detailed description and upon reference to the drawings in which:

FIG. 1 is a block diagram of a display system in accordance with an embodiment;

FIG. 2 is a schematic diagram of another display system in accordance with an embodiment;

FIG. 3 is perspective view of a mirror and adjacent fluorescent tubes, in accordance with an embodiment; and

FIG. 4 is a process flow diagram showing a method for providing backlight to a display system, in accordance with an embodiment.

### DETAILED DESCRIPTION

One or more specific embodiments of the present techniques will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Further, as used herein, terms describing geometric shapes, such as triangular, pyramidal, and point, should be understood to indicate that the shapes are not ideal shapes, but are substantially as described, e.g., substantially triangular, substantially pyramidal, and substantially small in area.

Embodiments of the present techniques provide a backlit display, such as a liquid crystal display (LCD), having an improved reflector for backlighting. The improved reflector may include beveled, e.g., triangular, reflectors under each fluorescent tube in a display backlight, which may direct the light from each of two adjoining tubes to form a composite image of a fluorescent tube. In effect, the composite image forms a virtual tube located between the two adjoining fluorescent tubes. Such a virtual tube may, for example, improve the amount and the alignments of the light reaching other components in the display. This may lower the number of fluorescent tubes required for effective illumination of a display and, thus, lower the power requirements of the display.

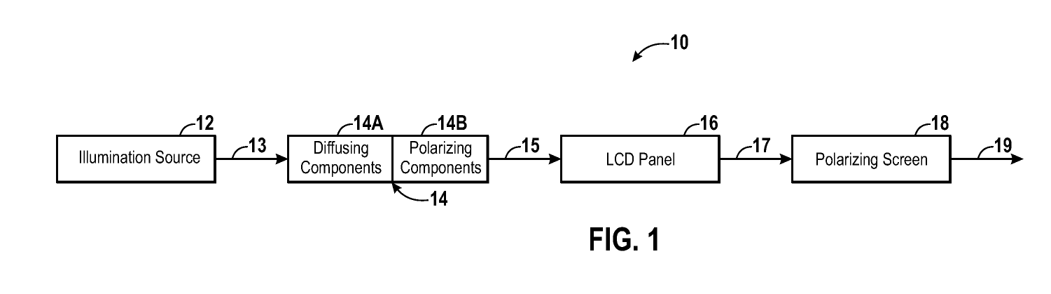

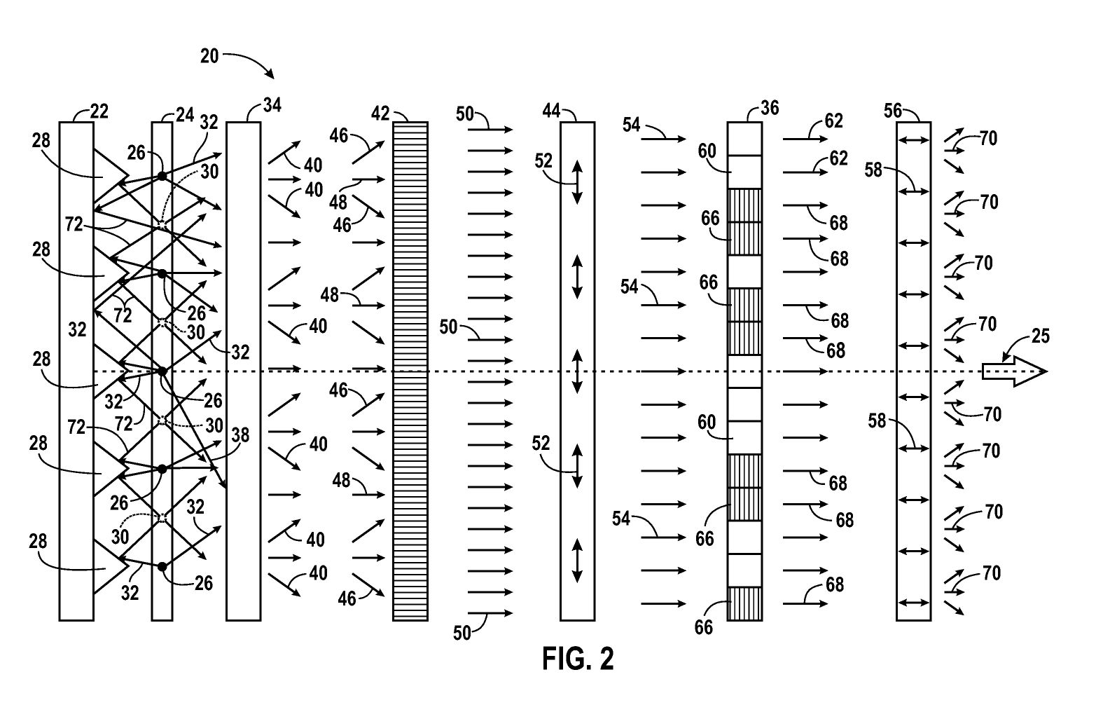

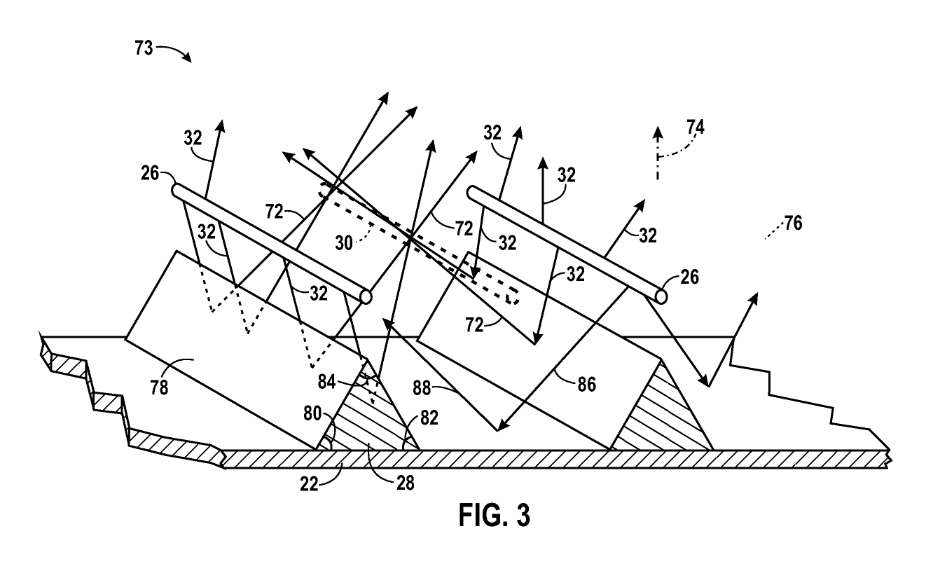

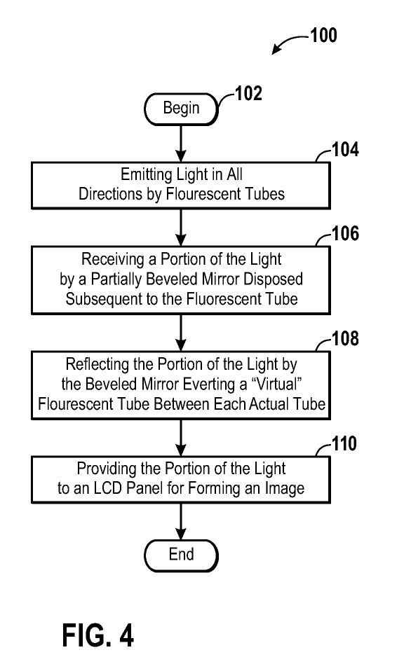

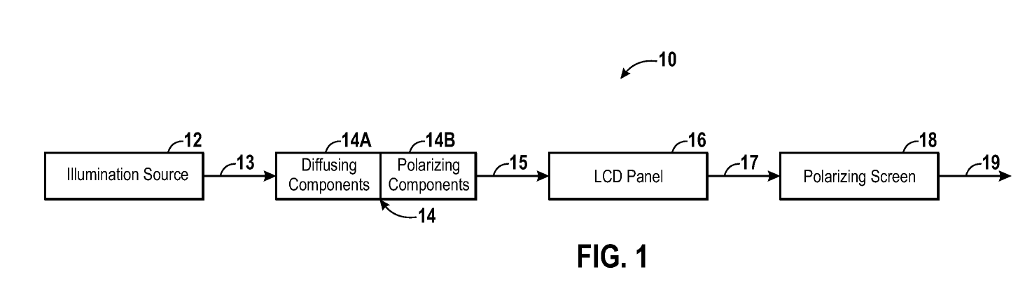

An overview of an LCD system 10 in accordance with an embodiment is provided in the block diagram shown in FIG. 1. It should be noted that the LCD system is set forth herein as an example of a backlit display. However, present embodiments are not limited to LCD technology. Indeed, embodiments of the present techniques may be incorporated into or include various types of backlit displays.

In some embodiments, the LCD system 10 may comprise an LCD monitor such as those used in computers, TVs or the like. The LCD system 10 includes an illumination system 12. As discussed in detail below, the illumination system 12 may include fluorescent tubes or other light producing devices configured to generate white or colored light 13 for providing backlight illumination for the LCD system 10.

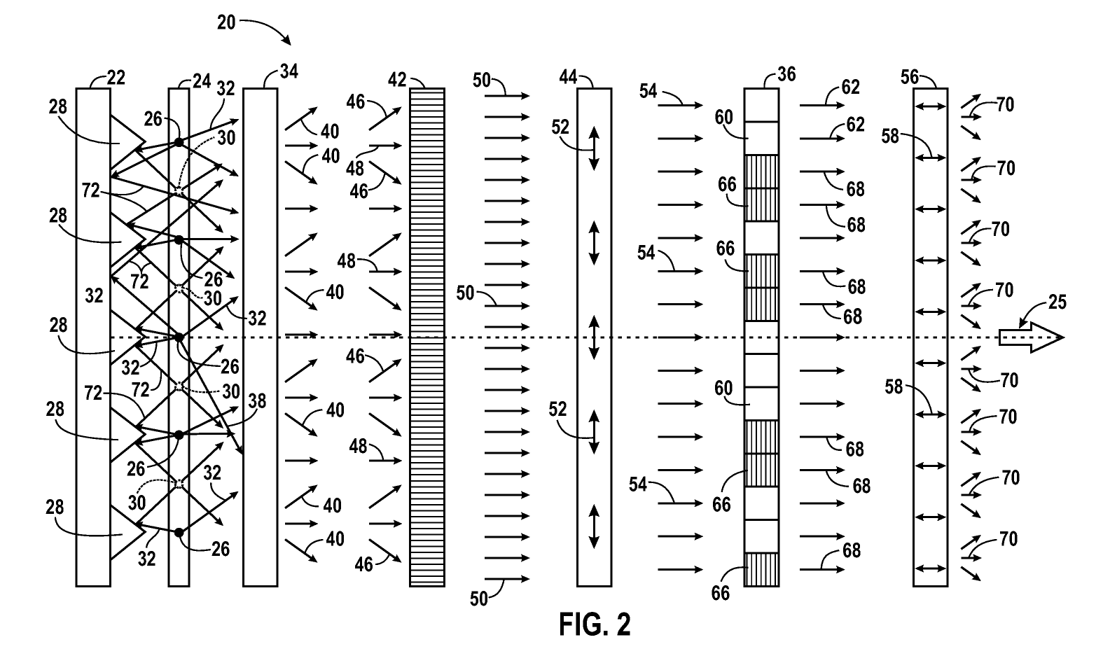

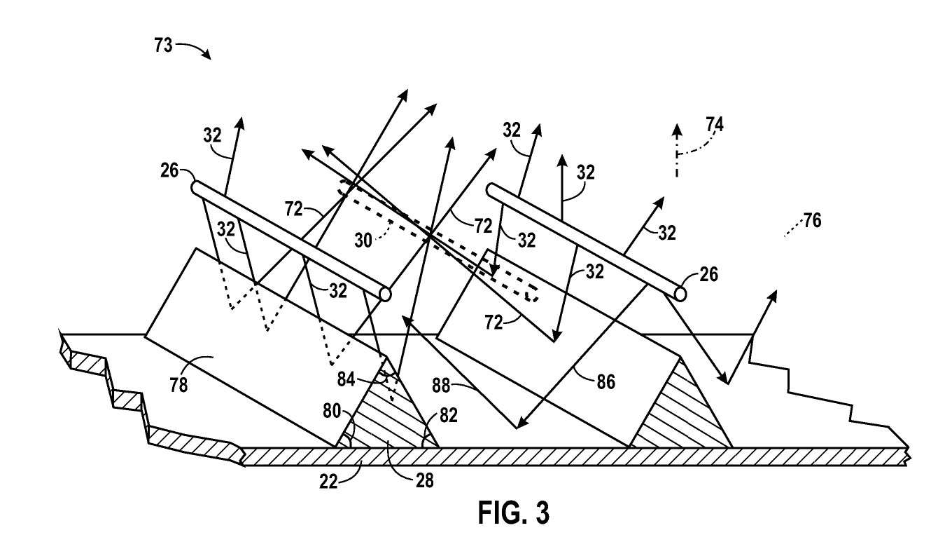

The illumination system 12 may include additional components, such as the beveled mirror discussed with respect to FIGS. 2 and 3, below, to focus the light 13 generated by the fluorescent tubes towards a display component, such as an LCD panel. The beveled mirror may, for example, be configured to create a composite image, e.g., a virtual tube, of two adjoining fluorescent tubes as discussed in further detail below.

The LCD system 10 may include a diffusing and polarizing element 14. The diffusing and polarizing element 14 may include a diffusing component 14A and a polarizing component 14B. The diffusing and polarizing element 14 may be adapted to diffuse the light 13 emanating from the illumination source 12. For example, the diffusing component 14A of the diffusing and polarizing element 14 may act to smooth or smear the light 13 to create a uniform backlight distribution. Further the diffusing component 14A may scatter light 13 towards the polarizing component 14B. The polarizing component 14B may function to linearly polarize the light 13 generated by the illumination source 12. Thus, the diffusing and polarizing element 14 may produce diffused and polarized light 15.

During operation of the LCD system 10, the diffused and polarized light 15 from the diffusing and polarizing element 14 passes through an LCD panel 16. In other embodiments, the LCD panel 16 may be replaced by different types of backlit panels. In the LCD panel 16, active micro-devices may modulate the light 15, for example, by changing the polarization axis of the light 15 in response to applied current, as discussed in detail with respect to FIG. 2, below. Thus, the LCD panel 16 may produce modulated light 17. As the amount of modulation is proportional to the current applied to a micro-device, the luminance of any single point in an image, such as a pixel, that is controlled by a particular micro-device may be adjusted.

During operation of the LCD system 10, the modulated light 17 from the LCD panel 16 is directed to a polarizing screen 18 to facilitate producing an image 19. The image 19 may be formed when the modulated light 17 at each pixel is either blocked to some degree or passed by the polarizing screen 18. The brightness of the image 19 may be determined by the degree of alignment of the polarization axis of the modulated light 17 with the polarization axis of the polarizing screen 18.

FIG. 2 is a more detailed representation of an LCD system 20 in accordance with an embodiment of the present techniques. The LCD system 20 shown in FIG. 2 depicts components that may be included within a display system in accordance with present embodiments, such as the LCD system 10. Further, FIG. 2 depicts the manner in which such components may function relative to one another for the generation of an image, in accordance with various embodiments. However, the present techniques are not limited to the method of forming an image discussed below. One of ordinary skill in the art will recognize that any number of other methods for forming an image may be used with an improved backlight containing virtual light sources.

As illustrated by FIG. 2, a mirror 22 is disposed at one end of the LCD system 20. The mirror 22 is generally configured to reflect light generated by a light source 24 towards an image 25 formed by the LCD system 20. The light source 24 may be disposed subsequent to the mirror 22 and closer to the front of the LCD system 20. Further, the light source 24 may include a plate containing light emitting devices. For example, the light source 24 may include a number of fluorescent tubes 26 configured to generate light for the LCD display 20. The number of fluorescent tubes 26 in the light source 24 may be varied to control factors such as the brightness, cost, or quality of a display. For example, a larger LCD system 20 may use more fluorescent tubes 26 to increase the brightness, such as 16, 18, 22, or even more tubes, while a smaller or portable unit may use fewer, such as 8, 10, or 14 tubes, to lower power demands. In other embodiments, the light source may be a panel having light emitting diode (LED) point sources placed across the front of the panel. In such embodiments, the mirror configuration would be modified appropriately, as discussed below.

As discussed in further detail with respect to FIG. 3 below, the mirror 22 may have beveled reflectors 28 positioned in alignment with each of the fluorescent tubes 26. The beveled reflectors 28 may reflect light 32 emitted from the fluorescent tubes 26 so as to create composite images, or virtual tubes 30, between each pair of adjoining fluorescent tubes 26. If the lighting is provided by point sources, such as LEDs, the mirrors may be made pyramidal with a beveled tip located generally under each LED.

In an embodiment, the LCD system 20 may include a diffuser 34. In embodiments, the diffuser 34 may be an opaque or translucent plastic film or glass sheet. The diffuser 34 may smooth or smear light from the fluorescent tubes 26 and virtual tubes 30 and, thus, more uniformly distribute the light. Further, proper image generation may depend on the extent to which the light from the light source 24 is polarized before reaching an LCD panel 36. The ability of the LCD system 20 to polarize the light may depend on the angular distribution of the light when it impinges on a polarizing filter. Accordingly, if the angular distribution of the light is too wide, this may result in backlight illumination that is only partially polarized. This may result in decreased image contrast, with the dark hues of an image being too light. The diffuser plate 34 may compensate for the wide angular distribution of light, for example, by scattering light towards the image 25 formed by the unit when the light is received by the diffuser plate 34 at a shallow angle, as represented by light beam 38. In various embodiments, scattered light 40 from the diffuser plate 34 may impinge a fiber optic screen 42 which may be placed between the diffuser 34 and a polarizer 44, as illustrated in FIG. 2. In other embodiments, the fiber optic screen 42 may be eliminated. In such embodiments, the polarizer 44 may be combined with the diffuser 34 to form a single unit.

The fiber optic screen 42 may, for example, be made from a large number of optical fibers joined in a longitudinal fashion (e.g., aligned with the image 25) to form a plate or screen. The fibers may be formed from any number of materials, including, for example, glass, plastic, or clear ceramics. The fiber optic screen 42 may substantially block scattered light, such as that represented by light beams 46, that is not adequately aligned with the component optical fibers. Further, the fiber optic screen 42 may pass light, such as that represented by light beams 48, that has an angular incidence on the fiber optic screen 42 within a few degrees (e.g., about 5°, 10°, or 15°) of perpendicular to the fiber optic screen 44. Thus, the fiber optic screen 42 may produce angularly aligned light 50. This may significantly improve the contrast of the image 25 produced by the LCD system 20 by lowering the amount of partially polarized light transmitted from the polarizer 40. The angularly aligned light 50 may then impinge on the polarizer 44.

The polarizer 44 may be formed of a polarizing material, such as a doped polymer or a similar material. Further, the polarizer 44 may be disposed within the LCD system 20 such that its polarization axis is oriented along a preferred direction relative to the LCD system 20, for example, vertically, as indicated by arrows 52. In this manner, the polarizer 44 polarizes the angularly aligned light 50 from the fiber optic screen 42 along the preferred direction to produce polarized light 54. The polarized light 54 may then be modulated by the LCD panel 36 to create the image.

The LCD panel 36 may be made up of active or passive micro-devices that include liquid crystal materials. For example, in one embodiment, the LCD panel 32 may comprise a matrix of active micro-devices that utilize thin film transistors (TFTs) disposed along pixel intersections of a grid comprising the display matrix. The luminance of the pixels of the LCD panel 36 may be controlled by the current applied by the TFTs. In another embodiment, the LCD panel 36 may comprise a passive matrix employing a grid of conductors, whereby the pixels are disposed along intersections of the display matrix. In such an embodiment, the pixels may be controlled by current driven across two conductors disposed along the grid comprising the matrix of pixels. As for the active matrix TFTs the luminance of an individual pixel may be controlled by the current applied.

In an embodiment of the LCD system 20, twisted nematic liquid crystals may be controlled by the micro-devices in the LCD panel 36 to form the image. One of ordinary skill in the art will recognize that any number of other technologies used to generate an image, both existing and not yet developed, may benefit from the reflectors of the present techniques.

Generally, in a twisted nematic liquid crystal display, the LCD panel 36 is located between two polarizing filters, for example the polarizer 44 and a polarizing screen 56. The polarization axis 52 of the polarizer 44 and a polarization axis 58 of the polarizing screen 56 may generally be perpendicularly aligned. For example, the polarization axis 58 of the polarizing screen 56 may be horizontally aligned if the polarization axis 52 of the polarizer 44 is vertically aligned.

In the LCD panel 36, the liquid crystal molecules in a non-energized cell 60 may rotate the polarization of the light from the polarizer 44 by 90°, such as from a vertical orientation to a horizontal orientation, to produce rotated light 62. If the polarizing screen 56 has a polarization axis 58 that is perpendicular to the polarizer 44, the rotated light 62 from the LCD panel may pass through the polarizing screen 56 and may form the image 25. In contrast, the liquid crystal molecules in an energized cell 66 may be aligned, thus allowing light 54 to pass through the energized cell 66 without rotating the polarization axis to produce light 68. Since, in this embodiment, the polarization of the emitted light 54 from the polarizer 44 has not been rotated, it is essentially perpendicular to the polarizing screen 56 and substantially blocked. Thus, light 70, which passed through the polarizing screen 56 and forms the image 25 seen by a viewer, has generally passed through a non-energized cell 60.

One of ordinary skill in the art will recognize that this is not the only configuration that may be used in an LCD. For example, in another embodiment, the polarization axis 52 for the polarizer 44 and the polarization axis 58 for the polarized screen 56 may be aligned. In this embodiment, rotated light from a non-energized cell 66 may be blocked by the polarizing screen 56.

As illustrated by FIG. 2, the fluorescent tubes 26 generally emit light 32 uniformly. Accordingly, the amount of light 32 propagating backwards toward the mirror 22 may be substantially equivalent to the amount of light 32 propagating forward toward the LCD panel 36. Thus, to increase the amount of backlight provided to the LCD panel 36, it may be desirable to reflect as much backward-propagating light as possible. Reflected light is represented by light beams 72. In addition to increasing the reflected light 72, it may be desirable to use the reflected light 72 to decrease the variations between lighter regions (e.g., regions nearer to the fluorescent tubes 26) and darker regions (e.g., regions farther from the fluorescent tubes 26). This may be performed in accordance with present embodiments by focusing the reflected light 72 to form virtual tubes 30, as discussed further with respect to FIG. 3, below.

A backlight illumination system 73, in accordance with present embodiments, is illustrated in FIG. 3. As shown in FIG. 3, fluorescent tubes 26 generally emit light 32 in every direction, including both forwards and backwards with respect to a display axis 74. For example, the light 32 emerging from the fluorescent tubes 26 propagates at varying angles relative to the display axis 74 of the LCD. Light emitted in the general direction of the display axis 74, may be directly scattered by the diffuser plate 34 (as discussed with reference to FIG. 2), and eventually used to form the image 25. Light emitted away from the display axis 74 may be reflected to assist in forming the image 25. The light beams 72 represent such reflected light.

As illustrated in FIG. 3, light 32 emitted away from the display axis 74 may impinge on the mirror 22, and be reflected back along the display axis 74 of the LCD. In accordance with present embodiments, the mirror 22 may have beveled reflectors 28 aligned with each of the fluorescent tubes 26. The beveled reflectors 28 may be triangular, with a top edge aligned with a centerline of the fluorescent tubes 26. Further In embodiments in which the light source does not include fluorescent tubes, the configuration of the bevel may be adapted to the configuration of the light source. For example, if the light source includes a grid of point sources, pyramidal beveled reflectors may be used with the point of each pyramid aligned with a center point of a light source. This configuration may, for example, focus light from the source to form virtual point light sources located between each of the actual adjoining light sources.

The shapes of each of the beveled reflectors 28 may be controlled to adjust the angle of light reflected and, thus, control the appearance of the virtual tube 30. For example, the sharpness of the virtual tube 30 may be adjusted by the angles of a surface 78 of each of the beveled reflectors 28. For example, a first intersection angle 80 of the surface 78 of the beveled reflectors 28 with the mirror 22 may be between about 10° and 80° or about 45°. A second intersection angle 82 may generally be about the same as the first intersection angle 80. Alternatively, the intersection angles 80 and 82 may differ to enhance the light reflection. For example, the intersection angles 80 and 82 may be different at the edges of the mirror 22. In one embodiment, the first intersection angle 80 may be set to 90° if the first intersection angle 80 is proximate to a side of the LCD. One of ordinary skill in the art will recognize that an apex angle 84 will be equal to 180° minus the sum of the intersection angles 80 and 82. For example, if the intersection angles 80 and 82 are equivalent at about 45°, the apex angle will equal about 90°.

The height of the beveled reflectors 28 may be adjusted relative to the positions of the fluorescent tubes 26 with respect to the mirror 22. In some embodiments, the beveled reflectors 28 may project from the mirror 22 about 10% to about 90% of the distance to the fluorescent tubes 26 or about 50% of the distance to the fluorescent tubes 26. In some embodiments, the distance between the mirror 22 and the fluorescent tubes 26 may be between about 2 millimeters (mm) and about 10 mm. In one embodiment, the distance between the mirror 22 and the fluorescent tubes is about 5 mm.

One of ordinary skill in the art will recognize that not all of the reflected light is reflected from the beveled reflectors 28. For example, light 86 may be reflected from the mirror 22 between the beveled reflectors 28. This reflected light, as represented by light beam 88, may not pass through the location of the virtual tube 30. Accordingly, the image of the virtual tube 30 may not be sharp or focused. In embodiments in which a sharper image is desired, the beveled reflectors 28 may be raised parabolic shapes formed into the mirror 22, with a focal point at the desired location for defining the virtual tubes 30.

The mirror 22 and beveled reflectors 28 may be formed from any number of materials including glass, metal, ceramic, or plastic. These materials do not need to be transparent as light will generally be reflected from them. The choice of materials may be made on the basis of functional properties, including, for example, stiffness, heat resistance, and weight, among others. Plastics that may used in embodiments include, for example, high impact polystyrene (HIPS), polycarbonate (PC), polyacrylate, polyphenylene sulfide, and polyvinylchloride (PVC), among others.

The beveled reflectors 28 may be formed on the surface of the mirror 22 using any number of techniques. Generally, the shapes may be formed prior to coating with a reflective surface, such as a mirror coating. For example, the beveled reflectors 28 may be formed as an integral part of the mirror 22 by molding, etching, photolithography, or any other suitable technique known in the art. Alternatively, the bevel reflectors 28 may be formed separately and joined to the surface of the mirror 22 by adhesive, ultrasonic welding, heat fusion, or any similar techniques used to join surfaces. After the mirror 22 with the beveled reflectors 28 has been formed, the reflective surfaces of the beveled reflectors 28 and of the mirror 22 will generally be coated (e.g., silvered) to increase the total amount of light reflected along the axis 74, toward the front of the LCD.

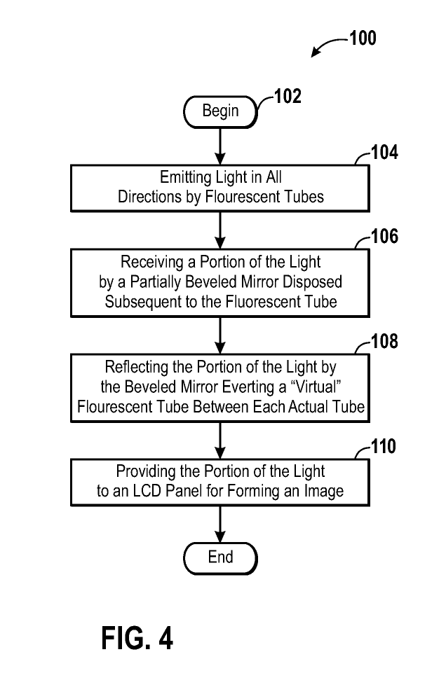

FIG. 4 is a process flow diagram showing a method for providing backlight to a display unit in accordance with an embodiment of the present techniques. The method is generally indicated by the reference number 100. The method 100 can be applied to the LCD systems described above in relation to FIGS. 1-3. The method 100 begins at block 102. Process flow then proceeds to block 104, where light is emitted in all directions by a plurality of fluorescent tubes, such as the fluorescent tubes 26 of the LCD display system 20 described with respected to FIGS. 2 and 3. Thereafter, the method 100 proceeds to block 106, whereby a portion the emitted light is received by a beveled reflector, such as beveled reflector 28 described in FIG. 3. As discussed above, this portion of the emitted light propagates away from the display axis, e.g., backward from the fluorescent tube and toward the mirror.

Next, the method 100 proceeds to block 108, where the beveled reflectors and mirror reflect the back-propagating portion of the light forward. This forward reflection may generally be along the display axis of the LCD, e.g., towards a polarizer and LCD panel. Accordingly, in one embodiment, at block 108, a portion of the light is reflected from the beveled reflectors aligned with each fluorescent tube to form a composite image of the adjoining fluorescent tubes, e.g., a virtual tube. Thereafter, at block 110, the emitted light of block 104 and the reflected light of block 108 propagate forward toward the LCD panel where the light is modulated to form an image. The use of such beveled reflectors to form virtual tubes may decrease the number of fluorescent tubes required and, thus, decrease the power requirements of a display. This may help to extend the battery life in portable devices.

While the present disclosure may be susceptible to various modifications and alternative forms, specific embodiments have been shown by way of example in the drawings and will be described in detail herein. However, it should be understood that the present disclosure is not intended to be limited to the particular forms disclosed. Rather, the present disclosure is to cover all modifications, equivalents and alternatives falling within the spirit and scope of the present disclosure as defined by the following appended claims.

What is claimed is:

1. A backlight illumination system, comprising:
a light source configured to emit light for illuminating a display unit, wherein the light source comprises at least two light emitters;
a mirror disposed behind the light source, wherein the mirror comprises beveled reflectors configured to reflect and focus the light so as to create a virtual light source.

2. The system of claim 1, wherein the display unit is a liquid crystal display (LCD).

3. The system of claim 1, wherein the at least two light emitters comprise at least two fluorescent tubes.

4. The system of claim 1, wherein the at least two light emitters are disposed adjacent one another on a plate.

5. The system of claim 4, wherein the virtual light source comprises a composite image of a light emitter located between the two adjacent light emitters.

6. The system of claim of claim 3, wherein the beveled reflectors are triangular.

7. The system of claim 1, wherein the beveled reflectors comprise a parabolic surface with a focal point between two adjacent light emitters.

8. The system of claim 1, wherein the at least two light emitters comprise at least two light emitting diodes.

9. The system of claim 8, wherein the beveled reflectors are pyramidal.

10. The system of claim 9, wherein the beveled reflectors comprise a parabolic surface with a focal point between each two adjacent light sources.

11. The system of claim 7, comprising a light pipe panel disposed between the light source and the LCD panel.

12. A method for providing backlight illumination to a display unit, comprising:
emitting light from a light source of the display unit;
reflecting a portion of the emitted light so as to create a virtual light source; and
providing the light from the light source and the virtual light source as a combined light to the display unit for forming an image.

13. The method of claim 12, comprising polarizing the combined light prior to providing the combined light to an LCD panel.

14. The method of claim 12, comprising applying an electric current to cells of the LCD panel to modulate the combined light.

15. The method of claim 12, comprising blocking light not substantially parallel to the axis of the display unit.

16. A liquid crystal display system, comprising:
a light source configured to emit light for illuminating a display unit;
a reflector disposed behind the light source, wherein the reflector is configured to focus the light to provide a virtual light source;
an LCD panel configured to modulate the light from the light source and the virtual light source; and
a screen configured to form an image based on the modulated light from the LCD panel.

17. The system of claim 16, wherein the light source comprises at least two fluorescent tubes.

18. The system of claim 17, wherein the reflector comprises a mirror comprising triangular beveled reflectors aligned with each of the at least two fluorescent tubes.

19. The system of claim 16, wherein the light source comprises at least two light emitting diodes.

20. The system of claim 19, wherein the reflector comprises a mirror comprising pyramidal beveled reflectors aligned with each of the light emitting diodes.

21. The system of claim 16, wherein the reflectors comprises a parabolic surface configured to focus the light.
